(19) United States
(12) Patent Application Publication
(10) Pub. No.: US 2013/0142720 A1
(43) Pub. Date: Jun. 6, 2013

(54) THE METHOD OF PREPARATION OF CERIUM OXIDE SUPPORTED GOLD-PALLADIUM CATALYSTS AND ITS APPLICATION IN DESTRUCTION OF VOLATILE ORGANIC COMPOUNDS

(71) Applicants: Yu-Wen Chen, Taipei City (TW); Hsien-Chang Yang, Hsinchu County (TW); Hsin-Hsien Wu, Hsinchu County (TW)

(72) Inventors: Yu-Wen Chen, Taipei City (TW); Hsien-Chang Yang, Hsinchu County (TW); Hsin-Hsien Wu, Hsinchu County (TW)

(73) Assignees: INDUSTRIAL TECHNOLOGY RESEARCH INSTITUTE, Hsinchu (TW); NATIONAL CENTRAL UNIVERSITY, Taoyuan County (TW)

(21) Appl. No.: 13/444,165

(22) Filed: Apr. 11, 2012

(30) Foreign Application Priority Data
Dec. 5, 2011 (TW) 100144587

(51) Int. Cl. B01D 53/44; B01J 23/66; B82Y 30/00

(52) U.S. Cl. 423/245.1; 502/304; 977/773; 977/902; 977/810

(57) ABSTRACT

This invention declares the method of preparation of cerium oxide supported palladium-gold catalysts and the process of destruction of volatile organic compounds in air to remove volatile organic compounds using the above catalysts. Destruction of volatile organic compounds in air stream over these catalysts is carried out in a fixed bed reactor to remove volatile organic compounds in air.

### CROSS-REFERENCE TO RELATED APPLICATION AND CLAIM OF PRIORITY

The present invention claims the benefits of priority from the Taiwanese Patent Application No. 100144587, filed on Dec. 5, 2011, the contents of the specification of which are hereby incorporated herein by reference.

### FIELD OF THE INVENTION

This invention relates to the method of preparation of cerium oxide supported palladium-gold catalysts and the process of destruction of volatile organic compounds in air to remove volatile organic compounds using the above catalysts. Destruction of volatile organic compounds in air stream over these catalysts is carried out in a fixed bed reactor to remove volatile organic compounds in air.

### BACKGROUND OF THE INVENTION

In recent years, due to the rapid industrial development driving the economic growth, the environmental pollution is correspondingly caused. Especially, the semiconductor industry could easily produce a large number of volatile organic compounds (Volatile Organic Compounds, VOCs) contaminants distributed in the air during the manufacturing process, and the corresponding pollution is an unavoidable issue for the relevant industry. VOCs refer to the carbon (C₂˜C₆) contained volatile substances of non-methane hydrocarbon such as benzene, toluene and nitrogen contained amines, etc., with the boiling point below 250° C. under normal circumstances. While most of VOCs are hazardous air pollutants, the human body exposed to VOCs in the environment, even at low concentrations, for a long-term period will appear the toxication phenomenon or carcinogenic tumors reaction. In addition, the VOCs in the atmosphere with a high degree of photochemical activity produce high-oxidation pollutants, such as the ozone, the PAN (peroxy acethyl nitrate), the PBN (peroxy benzene nitrate) through UV irradiation, which is awfully irritative and harmful to the human body. Therefore, how to reduce the harm of these pollutants on the environment and human is the researchers' goal.

Approaches for dealing with VOCs can be sketchily divided into two kinds as follows. One is removing scheme, which includes the high temperature and catalytic oxidation or reduction, as well as the biofiltration method. Under this mechanism, the organic pollutants are transformed into Carbon Dioxide and water. The other scheme is recycling, which uses methods, such as absorption, adsorption, condensation and membrane separation, to transfer or recycle pollutants from the waste gas, and make it become clean gas. In the early stage, VOCs are mostly treated by the high-temperature combustion method, and if there are sufficient Oxygen, temperature and reaction time, any hydrocarbon can be oxidized to Carbon Dioxide and water through the combustion process, and the foul-smelling gas can become tasteless and harmless gas and be emitted to the atmosphere. However, there are a variety of organic volatile gases, and each kind of gas has a different ignition point from another. Therefore, the temperature inside the furnace required to be reached for treating the volatile organic gases by the combustion method is also different. If there is a variety of volatile organic gas being mixed, the operating temperature and the conditions are more complex. Generally, an operating temperature of 700° C. to 900° C. or higher is required for a direct combustion stove in order to remove the majority of VOCs, but the heating process also costs a lot of energy (the electric and the diesel), which therefore causes the increase of the cost of processing. Thus, at the present time, the catalytic combustion method is often used for removing VOCs in industry, the catalytic combustion method, as compared with the direct combustion method, has the advantages as follows: (1) low-temperature treatment of organic pollutants, (2) high energy efficiency, and (3) no pollution to the environment from the product (which are Carbon Dioxide and water).

Catalysts for the treatment of organic pollutants are mainly divided into (1) low activity but cheap metal oxides (CuO, Cr₂O₃ and MnO₂ V₂O₅), and (2) high activity but also high price precious metals (Pt, Rh, Pd, Ag, and Au). The present invention selects the Palladium as a catalyst since the Palladium catalyst owns (1) lower prices, (2) good oxidation activity, and (3) high-temperature durability, as compared to other precious metals (Pt, Ag and Au, and Rh). Palladium as a precious metal with atomic number 46 belongs to the same family as Platinum and Nickel, and is on the same column of the periodic table as Rhodium and Silver. Palladium is a transition metal with gray color, excellent ductility and easy processing. The properties thereof are like those of platinum, but more susceptible to the acid corrosion than the platinum group metals. The melting point of Palladium is up to 1828K and thus is thermostable. The research of supported catalyst is an extremely important topic in the catalytic reaction. The support can increase the surface area of the active ingredient of the catalyst, change the properties of the catalyst, increase the activity and selectivity of the reaction, and greatly reduce the costs of the preparation for the precious metal catalyst.

Toluene is clear and colorless liquid, which has the notable smell and belongs to aromatic hydrocarbons as benzene. In the present practical applications, it is often used as organic solvent instead of the benzene having considerable toxicity. Many of its properties are very similar to those of the benzene, but the oxidation reaction thereof is different from that of benzene. The oxidation reaction of toluene does not perform on the benzene ring but in the methyl. Therefore, among the toluene oxidation products, there is only a very small amount of by-product (with strong carcinogenic epoxide) which often appear in the benzene oxidation reaction. Wu et al. [Catalysis Today Vol. 63 (2000) p. 419 to p. 426] found the platinum catalyst using the active carbon as the support, which oxidizes the toluene completely at temperature below 200° C., wherein the active carbon can be heated to 400° C. or 800° C. in the nitrogen stream, and the surface impurities or minerals thereof can be removed therefrom by hydrofluoric acid washing. Luo et al. [Applied Catalysis B: Environmental, Volume 69, 2007, p. 213 to p. 218] used CeO₂—Y₂O binary oxide as a support for preparing palladium catalyst and coated the catalyst on the honeycomb ceramic by wash-coating. They found that the catalyst calcined at 500° C. can completely oxidize the toluene at 210° C. In addition to high activity as aforementioned, the durability thereof is also a very important factor. The researchers repeatedly heated up the catalyst to 10° C. and reduced the catalyst to 10° C. for eight times between 200° C. to 240° C., and found no significant change happened to the catalytic activity within 30 hours, which shows the repeatability and stability thereof. Hosseini, et al. [Catalysis Today, Volume 122, 2007, p. 391 to p. 396] used the deposition-precipitation method and the impregnation method to load the gold and the Palladium onto high surface area titanium dioxide support, and activity order thereof are 0.5% Pd-1% Au/TiO₂>1.5% Pd/TiO₂>0.5% Pd/TiO₂>1% Au-0.5% Pd/TiO₂>1% Au/TiO₂>TiO₂. The most active one is 0.5% Pd-1% Au/TiO₂, which can completely oxidize the toluene at 230° C. Liu, et al. [Journal of Hazardous Materials, Vol. 149, 2007, p. 742 to p. 746] used the alumina, cerium oxide and zirconium dioxide prepared by co-precipitation as a hybrid support, and doped yttrium and manganese as additives. They prepared platinum catalyst by impregnation, and the experiments showed that Pt/γ-Al₂O₃/Ce_{0.4}Zr_{0.4}Mn_{0.1}Oₓ catalyst with yttrium and manganese as additives has the higher activity. The conversion rate of complete oxidation of the toluene can reach 90% at 216° C. Zheng, et al. [Catalysis Communications, Vol. 9 (2008), p. 990 to p. 994] used stainless steel as a support and the anodic oxidation process for preparation, and the catalyst having the best activity can be obtained by calcinating at 1000° C. The complete conversion temperature was 210° C. for toluene. Qingbao, et al. [Chinese Journal of Catalysis, Vol. 29 (2008), p. 373 to p. 378] used the properties of ZrO₂, such as the tetragonal phase easy to exchange Oxygen atoms, as well as wear resistance, high temperature resistance, corrosion resistance, and combined ZrO₂ with CeO₂ by an appropriate proportion. The final results showed that a 97% conversion of the toluene is obtained under the reaction temperature of 210° C. by using Pe/Ce_{0.8}Zr_{0.2}O₂/substrate as a monolithic catalyst under the calcination temperature of 400° C.

Taiwanese Patent Publication Number 200304850 disclosed a method for treating the organic waste gas by using the cooling condensing technology and the apparatus thereof. U.S. Pat. No. 5,753,583 disclosed a method for manufacturing a Palladium catalyst. According to the published patents, there was no such a method applying the nano cerium oxide supported gold-palladium catalyst for removing organic waste gas as disclosed in the present invention.

It is therefore attempted by the applicant to deal with the above situation encountered in the prior art.

### SUMMARY OF THE INVENTION

This invention declares the method of preparation of cerium oxide-supported palladium-gold catalysts and the process of destruction of volatile organic compounds in air to remove volatile organic compounds using the above catalysts. Destruction of volatile organic compounds in air stream over these catalysts is carried out in a fixed bed reactor to remove volatile organic compounds in air. The present invention uses incipient wetness method to impregnate the palladium nitrate (Pd(NO3)₂) liquid into the cerium dioxide (CeO₂) supported catalysts and calcine at any one temperature between 200° C. and 500° C. for two to ten hours. Nitrogen is passed through at any one temperature between 60° C. and 200° C. for removing moisture from the Pd catalyst, and then hydrogen is passed through for reduction for two hours. Au is loaded on the above prepared Pd catalyst by deposition-precipitation method. Equipollent tetrachloride auric acid (HAuCl₄) which needs to be prepared, having 0.1 to 1 weight percent Au, is measured to have HAuCl₄ liquid at a concentration of 1 to 4 M, and the HAuCl₄ liquid is dripped into the uniformly mixed Pd catalyst at a rate of 5 to 20 ml per minute. The pH value is controlled to be between 6 to 8 by ammonia water, and the temperature thereof is controlled at any one temperature between 50° C. and 80° C. and reflux for one to four hours, and then filter cake is filtered out. Chloride ions are washed out by distilled water at any one temperature between 50° C. and 60° C. The filtered liquid is tested by 1 M silver nitrate (AgNO3) liquid until there is no sediment generated and then dried at any one temperature between 60° C. and 100° C. for two to twenty hours. Nano gold-palladium catalyst is obtained by calcination at any one temperature between 100° C. and 200° C. for one to eight hours.

In accordance with the first aspect of the present invention, a cerium oxide supported gold-palladium catalyst is provided. The catalyst includes: an Au—Pd alloy having a gold (Au), palladium (Pd) and a particle size less than 5 nm; and Cerium Oxide particles, having a specific surface area more than 100 m²/g, for supporting the gold-palladium catalyst.

Preferably, the gold (Au) is 0.5 to 1 weight percent of the cerium oxide supported gold-palladium catalyst and the palladium (Pd) is 0.5 weight percent of the cerium oxide supported gold-palladium catalyst.

In accordance with the second aspect of the present invention, a method for manufacturing a cerium oxide supported gold-palladium catalyst is provided. The method includes: preparing a Pd catalyst; depositing an Au on the prepared Pd catalyst; and calcining at any one temperature between 100° C. and 200° C. for one to eight hours to obtain the gold-palladium catalyst.

Preferably, the preparing step further includes steps of: using an incipient-wetness impregnation method to impregnate a palladium nitrate (Pd(NO3)2) liquid into a cerium dioxide (CeO₂) supported catalyst and calcine at any one temperature between 200° C. and 500° C. for two to ten hours; and passing Nitrogen at any one temperature between 60° C. and 200° C. through the Pd catalyst for removing moisture thereform, and then passing a hydrogen therethrough for a reduction thereof for two hours.

Preferably, the depositing step further includes steps of: preparing a tetrachloride auric acid (HAuCl₄) liquid; dripping the HAuCl₄ liquid into the Pd catalyst at a rate of 5 to 20 ml per minute; controlling a pH value of the mixed Pd catalyst to be between 6 and 8 by an ammonia water, and a temperature thereof to be at any one temperature between 50° C. and 80° C. and reflux for one to four hours, and then filtering out filter cake; washing out Chloride ions by distilled water at any one temperature between 50° C. and 60° C.; testing filtered liquid by a 1 M silver nitrate (AgNO3) liquid until there is not sediment generated; and drying the filtered liquid at any one temperature between 60° C. and 100° C. for two to twenty hours.

Preferably, the preparing step further includes steps of: measuring an equipollent tetrachloride auric acid (HAuCl₄) having 0.1 to 1 weight percent Au to have a concentration of HAuCl₄ liquid at 1 to 4 M.

In accordance with the third aspect of the present invention, a method for removing organic waste gas in air is provided, which includes steps of: using a catalyst having cerium oxide supported gold-palladium, wherein the catalyst is the above cerium oxide supported gold-palladium catalyst.

Preferably, the method further includes a step of: using the catalyst reacting at any one temperature between 200° C. and 400° C. in the air such that the organic waste gas in the air is fully oxidized.

### BRIEF DESCRIPTION OF THE DRAWINGS

The foregoing and other features and advantages of the present invention will be more clearly understood through the following descriptions with reference to the drawings, wherein:

FIG. 1 illustrates XRD spectrums: (a) Pd/CeO₂, (b) 0.1 wt. % Au—Pd/CeO₂, (c) 0.5 wt. % Au—Pd/CeO, and (D) 1.0 wt. % Au—Pd/CeO₂;

FIG. 2 illustrates XPS Pd 3d spectrums: (a) Pd/CeO₂, (B) 0.1 wt. % Au—Pd/CeO, (C) 0.5 wt. % Au—Pd/CeO₂, and (d) 1.0 wt. % Au—Pd/CeO₂;

FIG. 3 illustrates the XPS Au 4f spectrums: (a) 0.1 wt. % Au—Pd/CeO₂, (b) 0.5 wt. % Au—Pd/CeO, (C) 1.0 wt. % Au—Pd/CeO₂, and (d) 1.0 wt. % Au/CeO₂; and

FIG. 4 illustrates the influences of the introduction of the different proportions of gold on the complete oxidation reaction of toluene.

### DETAIL DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

### Embodiment 1

Gold-Palladium Catalyst Preparation

Use the incipient-wetness impregnation method to impregnate the palladium nitrate (Pd(NO₃)₂) liquid into cerium dioxide (CeO₂) supported catalysts and calcine at any one temperature between 200° C. and 500° C. for two to ten hours. Pass nitrogen therethrough at any one temperature between 60° C. and 200° C. for removing the moisture from the Pd catalyst, and then pass hydrogen therethrough for reduction for two hours. Load Au on the above prepared Pd catalyst by the deposition-precipitation method. Measure equipollent tetrachloride auric acid (HAuCl₄) which needs to be prepared, having 0.1 to 1 weight percent Au, to have HAuCl₄ liquid at a concentration of 1 to 4 M, and dripping the HAuCl₄ liquid into the uniformly mixed Pd catalyst at a rate of 5 to 20 ml per minute. Control the pH value thereof to be between 6 to 8 by ammonia water, and control the temperature thereof at any one temperature between 50° C. and 80° C. and reflux for one to four hours, and then filtering out the filter cake. Wash out Chloride ions by distilled water at any one temperature between 50° C. and 60° C. Test filtered liquid by 1 M silver nitrate (AgNO₃) liquid until there is no sediment generated. Dry at any one temperature between 60° C. and 100° C. for two to twenty hours. Calcine at any one temperature between 100° C. and 200° C. for one to eight hours to obtain nano Gold-Palladium catalyst.

### Example 1

Prepare a Pd/CeO₂ catalyst by the incipient wetness method. The support is the cerium dioxide from Nikki Co., Ltd. Use incipient-wetness impregnation method to impregnate palladium nitrate (Pd(NO₃)₂) liquid into the Cerium dioxide (CeO₂) supported catalysts and calcine at 400° C. for six hours. Pass nitrogen through the Pd catalyst at 100° C. to remove the moisture, and then pass hydrogen/argon gas mixture therethrough at a rate of 50 ml/min for reduction at 300° C. for two hours. Load Au on the above prepared Pd catalyst by deposition-precipitation method. Measure equipollent tetrachloride auric acid (1 wt. % Au) which needs to be prepared in order to have Au liquid at a concentration of 2.25×10⁻³ M, and drip the liquid into the uniformly mixed Pd catalyst at a rate of 10 ml per minute. Control the pH value at 7 by ammonia water, and control the temperature at 65° C. and reflux for two hours, and then filtering out the filter cake. Wash out chloride ions by distilled water, and test the filtered liquid by 1 M silver nitrate (AgNO₃) liquid until there is no AgCl sediment generated. Dry at 80° C. for sixteen hours, and calcine at 200° C. for four hours to obtain nano gold-palladium catalyst.

Power X-Ray Diffraction (XRD) Analysis

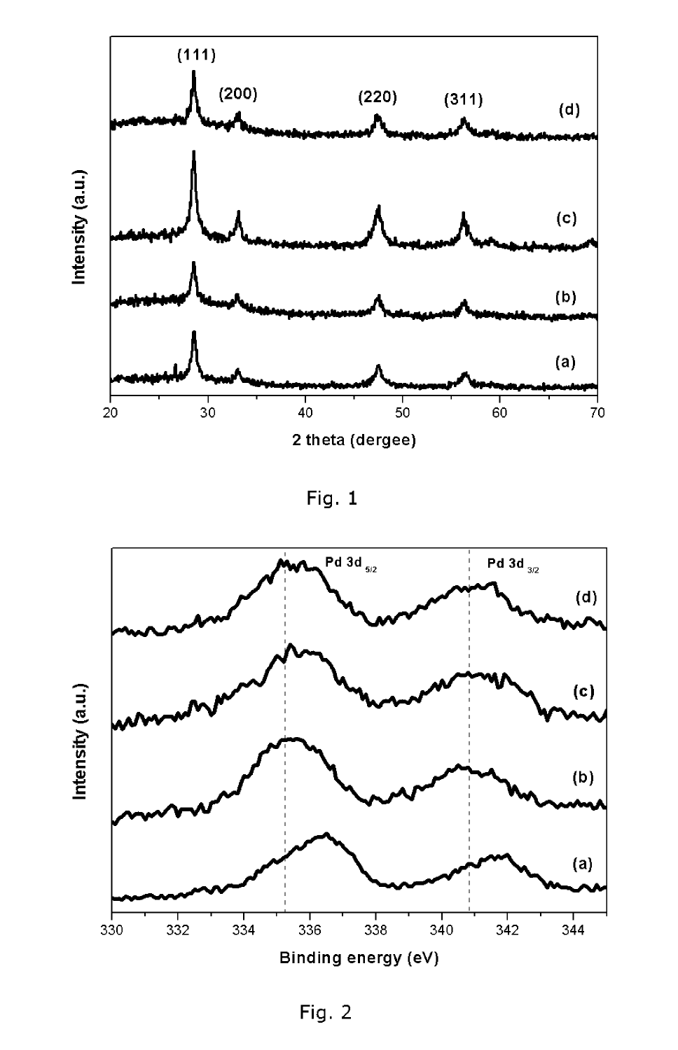

According to the powder X-ray diffraction peak, its width at half height can be used for obtaining the average size of the palladium particles on the supports and the size of the support crystalline grain. It is found through JCPDS database that the main peak 2θ of CeO₂ is 28.6° (111), and several smaller peaks are 33.1° (200), 47.5° (220), 56.3° (311) and 59.1° (222). After comparing, it is learned that the structure of Cerium Oxide is Fluorite body-centred cubic. FIG. 1 shows the introduction of different amounts of gold to the Pd/CeO₂ catalyst and the calcination for 4 hours at 180° C. There is no diffraction peak of gold (2θ=38.2°, 44.4°, 64.6°, 77.5°) being observed in the figure, which confirms that gold is uniformly dispersed in the Oxidized Cerium supports, or gold particles smaller than the XRD detection limit of 4 nm.

From the XRD patterns, it can be observed that the supports are all well crystallized cerium oxide, XRD patterns did not show the peaks of Palladium and gold, indicating that the palladium and gold particles are too small, less than the instrument detection limit (4 nm).

High-Resolution Electronic Microscope Analysis

It can be seen in the high-resolution electron microscope images that Palladium particles are on the cerium oxide supports, with the particle size about 2 nm. By appropriately introducing gold into palladium/cerium oxide catalysts, there will be part of the gold-palladium alloy formed, which can effectively reduce the complete conversion temperature of the toluene.

X-Ray Photoelectron Spectroscopy

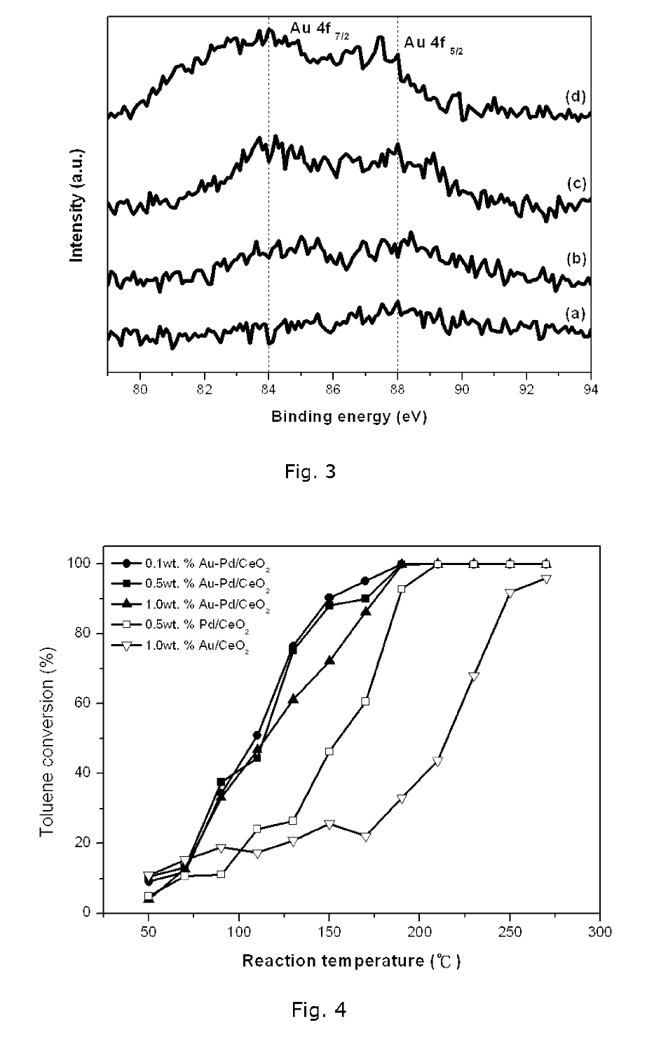

By X-ray photoelectron spectroscopy, the binding energy of the Palladium particle in the palladium catalyst can be known. Where all spectrums are corrected by using the binding energy 284.5 eV of C₁ₛ. After 0.5 N-wt. % Pd/CeO₂ are calcined at 400° C. for 8 hours, the binding energy shift of Pd of the catalyst is higher than the others, which stands for a strong interaction force of the metal and the support between the Pd and the CeO₂ surface, which can increase the stability of Palladium, and thereby increase the activity of the catalyst. If analyzing the signal peaks, the electron transition of the two orbital, 3d_{5/2} and 3d_{3/2} are mainly taken into account for Palladium, where the positions for the element states are at 336.5 eV and 341.6 eV. The bonding energy of the divalent Palladium are at 337.8 eV and 343.4 eV. The Palladium surface state on the Pd/CeO₂ catalyst can be obtained by XPS analysis. It can be found in FIG. 2 that after the gold is introduced into the Palladium/Cerium Oxide catalyst, 3d_{5/2} wave crest of the Pd shifts to the direction of lower binding energy. It can be found in FIG. 3 that after the gold is introduced into the Palladium/Cerium Oxide catalyst, 4f_{7/2} wave crest of the Au shifts to the direction of higher binding energy. The binding energy of the gold and the Palladium shift in the opposite direction since that part of the gold and the Palladium form into alloys.

### Embodiment 2

Put Au—Pd/CeO₂ catalyst into the fixed bed reactor for processing the reaction of complete oxidation of organic waste gas in the air by the continuous-flow fixed bed reactor. Control the flow rate of stream, and the reaction at 190° C.

### Example 2

Place the catalyst into the U-shaped fixed bed reactor for processing the reaction of oxidation of the toluene in the air by the continuous type fixed bed reactor. Control the flow rate at 40 ml per minute to pass into the reactor at room temperature. The tube has an inside and an outside diameters of 0.9 cm and 1.3 cm, length of 21 cm, and 0.5 cm melting quartz sand at the middle thereof for loading the catalyst for the reaction. 0.2 g of the catalyst is loaded in the U-shaped quartz tube. Place the toluene saturation device in the water bath to control the temperature at 30° C. Raise the reaction temperature of the catalytic from the room temperature to 250° C. After raising the temperature at a rate of 4° C./min for 5 minutes, maintain at the temperature when the reaction temperature is reached, and then process the test for the reaction 10 minutes later. Control the feeding flow rate through the flow controller, and first bring out the feeding vapor with a small amount of air through a flask filled with feeding toluene, and then dilute and adjust the feeding concentration by another air passing through the U-shaped catalyst fixed bed reactor. The gas after reaction flows through the gas chromatograph, and then is analyzed by the flame ionization detector. The reaction results are shown in FIG. 4, where the toluene conversion rate is defined as follows:

Toluene conversion rate=(imported toluene concentration−exported toluene concentration)=imported toluene concentration.

These results confirm that the catalyst of the present invention can effectively destruct the toluene in the air at 190° C. The result of the amount of gold introduced into a palladium catalyst for the toluene oxidation is shown in FIG. 4. Only 0.1 wt. % of gold is needed to improve the catalytic activity. The gold-palladium catalyst with the highest activity can be obtained by calcination at 180° C., which can completely destroy the toluene at 190° C.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A cerium oxide supported gold-palladium catalyst, comprising:
an Au—Pd alloy having a gold (Au), palladium (Pd) and a particle size less than 5 nm; and
cerium oxide particles, having a specific surface area more than 100 m²/g, for supporting the gold-palladium catalyst.

2. The cerium oxide supported gold-palladium catalyst as claimed in claim 1, wherein the gold (Au) is 0.5 to 1 weight percent of the cerium oxide supported gold-palladium catalyst and the palladium (Pd) is 0.5 weight percent of the cerium oxide supported gold-palladium catalyst.

3. A method for manufacturing a cerium oxide supported gold-palladium catalyst, comprising:
preparing a Pd catalyst;
depositing an Au on the prepared Pd catalyst; and
calcining at any one temperature between 100° C. and 200° C. for one to eight hours to obtain the gold-palladium catalyst.

4. The method as claimed in claim 3, wherein the preparing step further comprises steps of:
using an incipient wetness method to impregnate a palladium nitrate (Pd(NO₃)₂) liquid into a cerium dioxide (CeO₂) supported catalyst and calcine at any one temperature between 200° C. and 500° C. for two to ten hours; and
passing nitrogen at any one temperature between 60° C. and 200° C. through the Pd catalyst for removing moisture thereform, and then passing a hydrogen therethrough for a reduction thereof for two hours.

5. The method as claimed in claim 3, wherein the depositing step further comprises steps of:
preparing a tetrachloride auric acid (HAuCl₄) liquid;
dripping the HAuCl₄ liquid into the Pd catalyst at a rate of 5 to 20 ml per minute;
controlling a pH value of the mixed Pd catalyst to be between 6 and 8 by an ammonia water, and a temperature thereof to be at any one temperature between 50° C. and 80° C. and reflux for one to four hours, and then filtering out filter cake;
washing out Chloride ions by distilled water at any one temperature between 50° C. and 60° C.;
testing filtered liquid by a 1 M silver nitrate (AgNO₃) liquid until there is not AgCl sediment generated; and
drying the filtered liquid at any one temperature between 60° C. and 100° C. for two to twenty hours.

6. The method as claimed in claim 5, wherein the preparing step further comprises steps of: measuring an equipollent tetrachloride auric acid (HAuCl₄) having 0.1 to 1 weight percent Au to have a concentration of HAuCl₄ liquid at 1 to 4 M.

7. A method for removing organic waste gas in air, comprising steps of: using a catalyst having cerium oxide supported gold-palladium, wherein the catalyst is the cerium oxide supported gold-palladium catalyst as claimed in claim 1.

8. The method as claimed in claim 7 further comprises a step of: using the catalyst reacting at any one temperature between 200° C. and 400° C. in the air such that the organic waste gas in the air is fully oxidized.
